(19) United States
(12) Patent Application Publication
(10) Pub. No.: US 2026/0019960 A1
(43) Pub. Date: Jan. 15, 2026

(54) SYSTEMS, APPARATUSES, METHODS, AND NON-TRANSITORY COMPUTER-READABLE STORAGE DEVICES FOR MULTI-LINK SIMULTANEOUS TRANSMIT AND RECEIVE OPERATIONS IN WIRELESS LOCAL-AREA NETWORK

(71) Applicant: HUAWEI TECHNOLOGIES CO., LTD., Shenzhen (CN)

(72) Inventors: Mahmoud Hasabelnaby, Kelowna (CA); Osama Aboul-Magd, Kanata (CA); Yan Xin, Kanata (CA); Jung Hoon Suh, Kanata (CA); Sara Norouzi, Vancouver (CA)

(21) Appl. No.: 18/965,005

(22) Filed: Dec. 2, 2024

Related U.S. Application Data
(60) Provisional application No. 63/669,475, filed on Jul. 10, 2024.

(51) Int. Cl. H04W 52/36; H04W 60/04; H04W 74/0816

(52) U.S. Cl. CPC H04W 52/367; H04W 60/04; H04W 74/0816

(57) ABSTRACT

A communication method has the step of: receiving from a multi-link device (MLD) a minimum transmit power and a maximum transmit power for each of a first communication link and a second communication link; and notifying the MLD to set a transmit power of each of the first and second communication links to a respective upper limit thereof; wherein the upper limit of each of the first and second communication links is the respective maximum transmit power thereof if a frequency gap between the first communication link and the second communication link is greater than a threshold, or is the respective minimum transmit power thereof if the frequency gap is smaller than the threshold.

### CROSS-REFERENCE TO RELATED APPLICATION

This application claims the benefit of U.S. Provisional Patent Application Ser. No. 63/669,475, filed Jul. 10, 2024, the content of which is incorporated herein by reference in its entirety.

### FIELD OF THE DISCLOSURE

The present disclosure relates generally to communication systems, apparatuses, methods, and non-transitory computer-readable storage media, and in particular to systems, apparatuses, methods, and non-transitory computer-readable storage media for power-controlled multi-link simultaneous transmit and receive operations in wireless local-area network (WLAN) with in-device coexistence (IDC) awareness.

### BACKGROUND

Wireless communication systems such as wireless local-area network (WLAN) systems are known. In WLAN systems, the multi-link simultaneous transmit and receive (STR) transmission mode, as outlined in IEEE P802.11be/D5.0-35.3.16.3, permits access point (AP) and/or non-AP multi-link devices (MLDs) to asynchronously transmit frames on multiple different links. Each affiliated AP or non-AP station (STA) maintains its own channel access parameters, behaving independently of the others. STR facilitates concurrent uplink (UL) and downlink (DL) communications. However, such system can have high power consumption and can be affected by in-device coexistence (IDC) interference.

Therefore, there is a desire for power control and solving the IDC issues.

### SUMMARY

According to one aspect of this disclosure, there is provided a communication method comprising: receiving from a multi-link device (MLD) a minimum transmit power and a maximum transmit power for each of at least a first communication link and a second communication link for use by at least a first communication component and a second communication component of the MLD, respectively; checking if a frequency gap between the first communication link and the second communication link is greater than a threshold; and notifying the MLD to set transmit powers of the first and second communication links; wherein said notifying the MLD to set the transmit powers of the first and second communication links comprises: if the frequency gap is greater than the threshold, notifying the MLD to set transmit powers of the first and second communication links to values smaller than or equal to the respective maximum transmit powers; and if the frequency gap is smaller than the threshold, notifying the MLD to set transmit powers of the first and second communication links to the respective minimum transmit powers.

In some embodiments, said receiving from the MLD the minimum transmit power and the maximum transmit power for each of the first communication link and the second communication link comprises: receiving, from the MLD via association request frame, the minimum and maximum transmit powers for each of the first and second communication links; the association request frame comprises a Multi-Link Power Capability element, the Multi-Link Power Capability element comprising a Control field and a Transmit Power Capabilities field; the Transmit Power Capabilities field specifies the minimum and maximum transmit powers for each of the first and second communication links; and the Control field comprising a Number of Links subfield for indicating a number of a plurality of communication links specified in the Transmit Power Capabilities field, the plurality of communication links comprising the first and second communication links.

In some embodiments, said notifying the MLD to set the transmit powers of the first and second communication links comprises: notifying the MLD, via an association response frame, to set the transmit powers of the first and second communication links; the association response frame comprises a Control field and a Local Power Constraint field; the Local Power Constraint field specifies a local power constraint for each of the first and second communication links; and the Control field comprises a Number of Links subfield for indicating the number of the plurality of communication links specified in the Local Power Constraint field, the plurality of communication links comprising the first and second communication links.

According to one aspect of this disclosure, there is provided a communication method comprising: receiving from a multi-link device (MLD) a minimum transmit power and a maximum transmit power for each of a first communication link and a second communication link; and notifying the MLD to set a transmit power of each of the first and second communication links to a respective upper limit thereof; wherein the upper limit of each of the first and second communication links is the respective maximum transmit power thereof if a frequency gap between the first communication link and the second communication link is greater than a threshold, or is the respective minimum transmit power thereof if the frequency gap is smaller than the threshold.

In some embodiments, said receiving from the MLD the minimum transmit power and the maximum transmit power for each of the first communication link and the second communication link comprises: receiving, from the MLD via an association or reassociation request frame, the minimum and maximum transmit powers for each of the first and second communication links; wherein the association or reassociation request frame comprises a Multi-Link Power Capability element, the Multi-Link Power Capability element comprising a Transmit Power Capabilities field; and wherein the Transmit Power Capabilities field of the Multi-Link Power Capability element indicates the minimum and maximum transmit powers for each of the first and second communication links.

In some embodiments, the Multi-Link Power Capability element comprises a Control field; and the Control field of the Multi-Link Power Capability element comprising a Number of Links subfield for indicating a number of a plurality of communication links whose minimum and maximum transmit powers are indicated in the Transmit Power Capabilities field of the Multi-Link Power Capability element, the plurality of communication links comprising the first and second communication links.

In some embodiments, the Control field of the Multi-Link Power Capability element has a length of one byte, and the Number of Links subfield of the Control field of the Multi-Link Power Capability element has a length of four bits, and each of the minimum and maximum transmit powers for the plurality of communication links is indicated in the Transmit Power Capabilities field of the Multi-Link Power Capability element using one byte.

In some embodiments, each of the minimum and maximum transmit powers for the plurality of communication links is indicated in the Transmit Power Capabilities field of the Multi-Link Power Capability element as a value of power subject to a tolerance.

In some embodiments, each of the minimum and maximum transmit powers for the plurality of communication links is indicated in the Transmit Power Capabilities field of the Multi-Link Power Capability element as a two's complement signed integer in units of decibels relative to one milliwatts (mW).

In some embodiments, said notifying the MLD to set the transmit power of each of the first and second communication links to the respective upper limit thereof comprises: notifying the MLD, via an association or reassociation response frame, to set the transmit power of each of the first and second communication links to the respective upper limit thereof; wherein the association or reassociation response frame comprises a Power Constraint element, the Power Constraint element comprising a Local Power Constraint field; wherein the Local Power Constraint field of the Power Constraint element indicates the upper limit of each of the first and second communication links.

In some embodiments, the Power Constraint element comprising a Control field; and the Control field of the Power Constraint element comprises a Number of Links subfield for indicating the number of the plurality of communication links whose upper limits are indicated in the Local Power Constraint field of the Power Constraint element.

In some embodiments, the Control field of the Power Constraint element has a length of one byte, and the Number of Links subfield of the Control field of the Power Constraint element has a length of four bits, and each upper limit is indicated in the Local Power Constraint field of the Power Constraint element using one byte.

In some embodiments, each upper limit is indicated in the Local Power Constraint field of the Power Constraint element as a value of power.

In some embodiments, each upper limit is indicated in the Local Power Constraint field of the Power Constraint element as a two's complement signed integer in units of decibels relative to one mW.

In some embodiments, said receiving from the MLD the minimum transmit power and the maximum transmit power for each of the first communication link and the second communication link comprises: receiving, from the MLD via an association or reassociation request frame, the in minimum and maximum transmit powers for each of the first and second communication links; wherein the association or reassociation request frame comprises a first Ultra-High Reliability (UHR) Multi-Link element being a first UHR Basic Multi-Link element or a first UHR Reconfiguration Multi-Link element, the first UHR Multi-Link element comprising a Multi-Link Control field and a Link Info field; wherein the Multi-Link Control field of the first UHR Multi-Link element comprises a Type subfield having a value of five or six; wherein the Link Info field of the first UHR Multi-Link element comprises a plurality of Per-STA Profile subelements for the first and second communication links, respectively, each Per-STA Profile subelement comprising a STA Info field; and wherein the STA Info field of the Per-STA Profile subelement of the first UHR Multi-Link element indicates the minimum and maximum transmit powers for the corresponding one of the first and second communication links.

In some embodiments, each Per-STA Profile subelement comprising a STA Control field; and the STA Control field of the Per-STA Profile subelement of the first UHR Multi-Link element comprises a Power Capabilities Present subfield having a value of one.

In some embodiments, each of the minimum and maximum transmit powers is indicated in the STA Info field of the Per-STA Profile subelement of the Link Info field of the first UHR Multi-Link element using one byte.

In some embodiments, each of the minimum and maximum transmit powers for the plurality of communication links is indicated in the STA Info field of the Per-STA Profile subelement of the Link Info field of the first UHR Multi-Link element as a value of power subject to a tolerance.

In some embodiments, each of the minimum and maximum transmit powers is indicated in the STA Info field of the Per-STA Profile subelement of the Link Info field of the first UHR Multi-Link element as a two's complement signed integer in units of decibels relative to one mW.

In some embodiments, said notifying the MLD to set the transmit power of each of the first and second communication links to the respective upper limit thereof comprises: notifying the MLD, via an association or reassociation response frame, to set the transmit power of each of the first and second communication links to the respective upper limit thereof; wherein the association or reassociation request frame comprises a second UHR Multi-Link element being a second UHR Basic Multi-Link element or a second UHR Reconfiguration Multi-Link element, the second UHR Multi-Link element comprising a Multi-Link Control field and a Link Info field; wherein the Multi-Link Control field of the second UHR Multi-Link element comprises a Type subfield having a value of five or six; wherein the Link Info field of the second UHR Multi-Link element comprises a plurality of Per-STA Profile subelements for the first and second communication links, respectively, each Per-STA Profile subelement of the second UHR Multi-Link element comprising a STA Info field; and wherein the STA Info field of the Per-STA Profile subelement of the second UHR Multi-Link element indicates the upper limit of each of the first and second communication links.

In some embodiments, each Per-STA Profile subelement of the second UHR Multi-Link element comprising a STA Control field; and the STA Control field of the Per-STA Profile subelement of the second UHR Multi-Link element comprises a Local Power Constraint Present subfield having a value of one.

In some embodiments, each upper limit is indicated in the STA Info field of the Per-STA Profile subelement of the second UHR Multi-Link element using one byte.

In some embodiments, each upper limit is indicated in the STA Info field of the Per-STA Profile subelement of the second UHR Multi-Link element as a value of power.

In some embodiments, each upper limit is indicated in the STA Info field of the Per-STA Profile subelement of the second UHR Multi-Link element as a two's complement signed integer in units of decibels relative to one mW.

In some embodiments, the Multi-Link Control field of the second UHR Multi-Link element comprises a Type subfield having a value of six; and wherein the STA Control field of the Per-STA Profile subelement of the second UHR Multi-Link element comprises a UHR Reconfiguration Operation Type subfield having a value five for indicating local power update.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus comprising: one or more processors functionally connected to one or more non-transitory computer-readable storage media such as one or more memories for performing the above-described methods.

According to one aspect of this disclosure, there is provided one or more non-transitory computer-readable storage media comprising computer-executable instructions, wherein the instructions, when executed, cause one or more circuits to perform the above-described methods.

According to one aspect of this disclosure, there is provided an apparatus, and configured to perform the any one of above-mentioned methods and their embodiments. Specifically, the apparatus includes one or more units configured to perform the any one of above-mentioned methods and their embodiments.

According to one aspect of this disclosure, there is provided a computer-readable storage medium. The computer-readable storage medium stores a computer program, and when the computer program is executed by an apparatus, the apparatus is enabled to implement the any one of above-mentioned methods and their embodiments.

According to one aspect of this disclosure, there is provided a computer program product including one or more instructions. When the instructions are executed by an apparatus such as a computer, the apparatus is enabled to implement the any one of above-mentioned methods and their embodiments.

According to one aspect of this disclosure, there is provided a computer program. When the computer program is executed by a computer, an apparatus is enabled to implement the any one of above-mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

The method disclosed herein provides various advantageous effects.

For example, unlike previous works that switch to the non-simultaneous transmit and receive (NSTR) mode, the method disclosed herein adjusts the transmission power values on the in-device coexistence (IDC) impacted links, thereby enabling simultaneous uplink and downlink transmissions over IDC-impacted links and mitigating or even eliminating the otherwise significant issue of IDC interference in simultaneous transmit and receive (STR) multi-link operations;

Accordingly, the method disclosed herein enables multi-link STR operations with maximized throughput and minimized latency, thereby exhibiting a significant improvement over prior-art methods that often require switching to NSTR mode which compromises the throughput and latency.

In some embodiments, the method disclosed herein is particularly beneficial for delay-sensitive applications such as Internet-of-things (IoT) devices operations and online gaming, wherein the delay requirements are stringent, and applying restricted channel access or enhanced distributed channel access (EDCA) backoff suspension methods as in the NSTR mode may not be feasible in these scenarios.

In some embodiments, the method disclosed herein uses various signaling approaches for the power capabilities and constraints information exchange/update between access point (AP) multi-link devices (MLDs) and non-AP MLDs (such as station (STA) MLDs), such as extending the existing Power Capability and Power Constraint elements to multi-link operations, and/or introducing the Ultra-High Reliability (UHR) Basic Multi-Link element to include the power capabilities/constraint present and value subfields into the STA Control and STA Info fields. A UHR Reconfiguration Multi-Link element is also introduced for providing recommendation for ML reconfiguration to the associated non-AP MLDs for updating the local transmit power constraint for an affiliated STA. These extended elements represent significant enhancements in the management of multi-link operations.

In some embodiments, the method disclosed herein provides a clear and measurable criterion for managing transmission power in a network to handle IDC interference during STR multi-link operations, which reduces the complexity involved in network management, and is a significant improvement over prior-art methods (which often involved complex end-time alignment, or transmission/transmission (TX/TX) and/or receiving/receiving (RX/RX) operations synchronization).

In some embodiments, the method disclosed herein provides flexible power control based on the frequency gap between affiliated STAs, the presence of IDC interference, and the dynamic changes of the network. Such a flexibility allows the system to maintain good performance and minimize interference in various scenarios, making it a more robust and adaptable solution.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing multi-link transmit and receive (STR) operations of the communication system shown in FIG. 1;

FIG. 5 is a schematic diagram illustrating the in-device coexistence (IDC) interference issue in multi-link STR operations;

FIG. 6 is a schematic diagram illustrating restricted channel access rules in prior art;

FIG. 7 is a schematic diagram illustrating a prior-art method for dealing with the IDC interference issue;

FIG. 8 is a schematic diagram showing a power-controlled multi-link STR operation method for managing the IDC interference in multi-link STR operations, according to some embodiments of this disclosure;

FIG. 9 is a schematic diagram showing the detail of a local maximum transmit power constraint determination step of the power-controlled multi-link STR operation method shown in FIG. 8, according to some embodiments of this disclosure;

FIG. 10 is a schematic diagram showing the structure of a Multi-Link Power Capability element of a (re) association request frame, according to some embodiments of this disclosure;

FIG. 11 is a schematic diagram showing the structure of the Control field of the Multi-Link Power Capability element shown in FIG. 10;

FIG. 12 is a schematic diagram showing the structure of the Transmit Power Capabilities field of the Multi-Link Power Capability element shown in FIG. 10;

FIG. 13 is a schematic diagram showing the structure of a Multi-Link Power Constraint element of a (re) association request frame, according to some embodiments of this disclosure;

FIG. 14 is a schematic diagram showing the structure of the Control field of the Multi-Link Power Constraint element shown in FIG. 13;

FIG. 15 is a schematic diagram showing the structure of the Local Power Constraint field of the Multi-Link Power Constraint element shown in FIG. 13;

FIG. 16 is a schematic diagram showing the structure of a multi-link element of a (re) association request frame, according to some embodiments of this disclosure;

FIG. 17 is a schematic diagram showing the structure of the Per-STA Profile subelement of the Ultra-High Reliability (UHR) Basic Multi-Link element of a (re) association request frame, according to some embodiments of this disclosure;

FIG. 18 is a schematic diagram showing the structure of the STA Control field of the Per-STA Profile subelement shown in FIG. 17;

FIG. 19 is a schematic diagram showing the structure of the STA Info field of the Per-STA Profile subelement shown in FIG. 17;

FIG. 20 is a schematic diagram showing the structure of the Per-STA Profile subelement of the UHR Reconfiguration Multi-Link element of a (re) association request frame, according to some embodiments of this disclosure;

FIG. 21 is a schematic diagram showing the structure of the STA Control field of the Per-STA Profile subelement shown in FIG. 20;

FIG. 22 is a schematic diagram showing the structure of the STA Info field of the Per-STA Profile subelement shown in FIG. 20;

### DETAILED DESCRIPTION

Embodiments disclosed herein relate to wireless communication systems, apparatuses, methods, and non-transitory computer-readable storage media for power-controlled multi-link simultaneous transmit and receive operations in wireless local-area network (WLAN) with in-device coexistence (IDC) awareness. The wireless communication systems, apparatuses, and methods disclosed herein may be any suitable systems, apparatuses, and methods for transmitting wireless signals. Examples of such systems may be wireless local-area network (WLAN) Ultra-High Reliability (UHR) systems (for example, IEEE 802.11bn or WI-FI® 8 systems), 5G or 6G wireless mobile communication systems, and the like.

a. System Structure

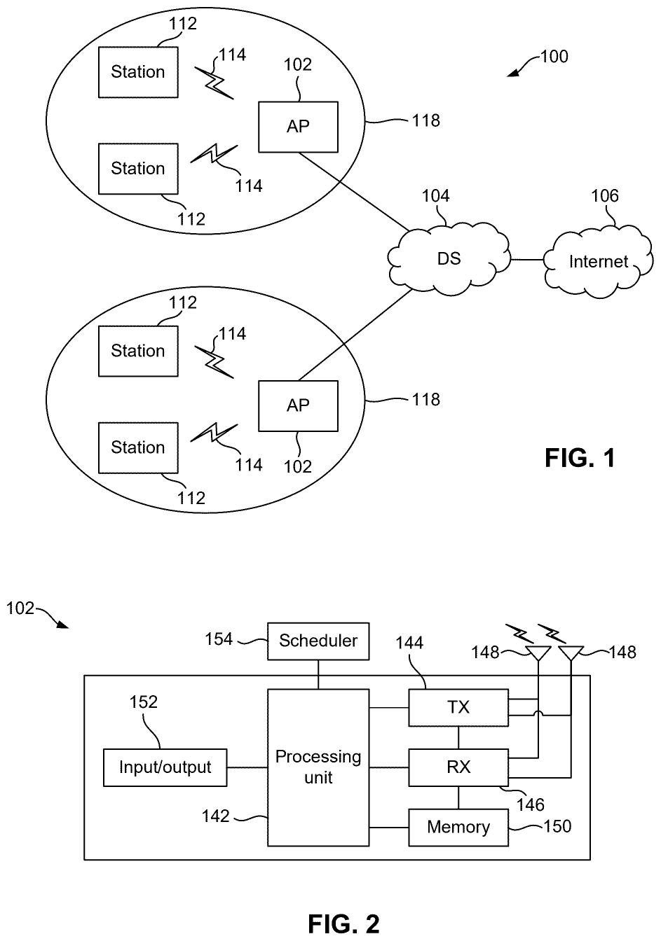

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX; also used as the abbreviation of “transmission”) 144, at least one receiver (RX; also used as the abbreviation of “receiving”) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

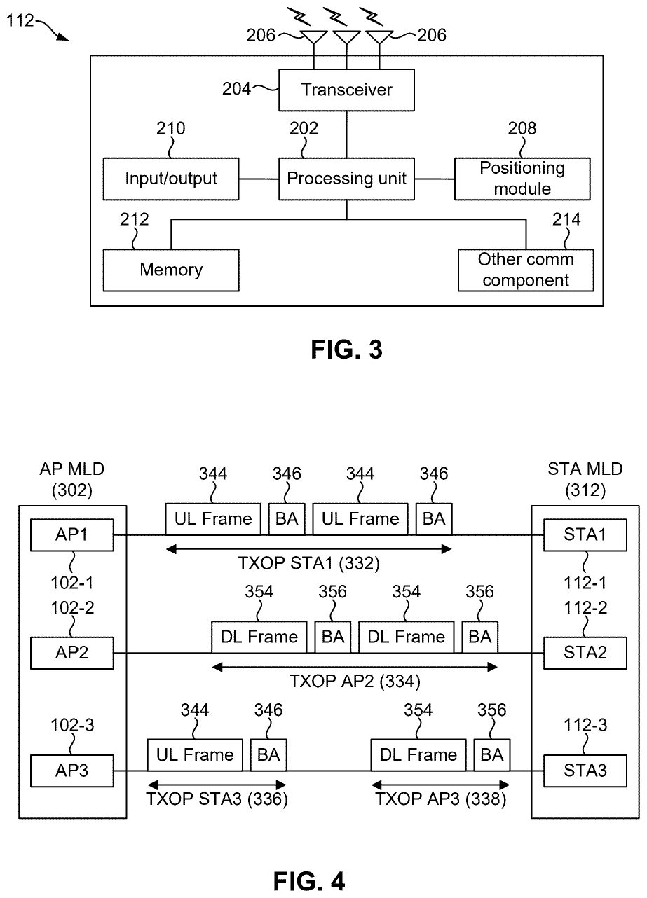

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Globa “naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Idc-Aware Power-Controlled Multi-Link Simultaneous Transmit and Receive Operations in Wlan

The communication system 100 may operate in the multi-link simultaneous transmit and receive (STR) transmission mode, which permits AP/non-AP multi-link devices (MLDs) to asynchronously transmit frames on multiple different links. FIG. 4 is a schematic diagram showing multi-link STR operations. As shown, an AP MLD 302 may establish a plurality of links with a plurality of devices (such as one or more STA MLDs 312). For simplicity of notation, the component of the AP MLD 302 responsible for establishing a link is denoted as an affiliated AP 102. Similarly, a non-AP MLD 312 such as a STA MLD may establish a plurality of links with a plurality of devices (such as one or more AP MLDs 302). For simplicity of notation, the component of the non-AP MLD 312 (such as a STA MLD) responsible for establishing a link is denoted as an affiliated device (such as an affiliated STA 112).

STA1 112-1 may transmit, in a transmission opportunity (TXOP) 332, one or more UL frames 344 to AP1 102-1, and AP1 102-1 may send one or more block acknowledgements (BAs) 346 to STA1 112-1 for acknowledging successful reception of the UL frames 344.

AP2 102-2 may transmit, in a TXOP 334, one or more DL frames 354 to STA2 112-2, and STA2 112-2 may send one or more BAs 356 to AP2 102-2 for acknowledging successful reception of the DL frames 354.

STA3 112-3 may transmit, in a TXOP 336, one or more UL frames 344 to AP3 102-3, and AP3 102-3 may also transmit, in a TXOP 338, one or more DL frames 354 to STA3 112-3. AP3 102-3 and STA3 112-3 may send one or more BAs 346 and 356 to acknowledge successful reception of frames 344 and 354, respectively.

In the multi-link STR transmission mode, each affiliated AP 102 or STA 112 maintains its own channel access parameters, behaving independently of the others. STR facilitates concurrent UL and DL communications. There are several advantages to this approach. It allows for independent channel contention on all links and enables independent transmission and reception on all links. This offers a high potential for increased throughput. However, there are also some drawbacks. The AP MLD 302 and/or non-AP MLD 312 can experience high power consumption and can be affected by IDC interference.

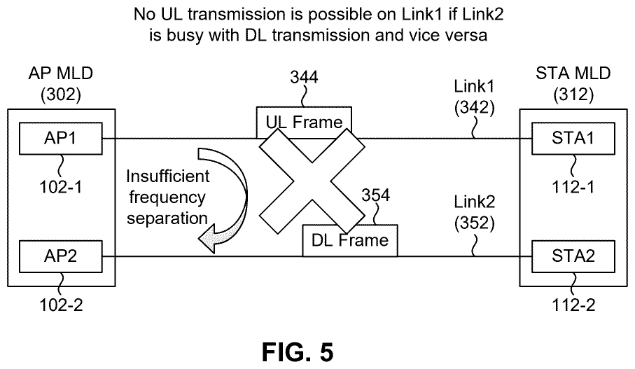

The STR mode can lead to a cross-link interference over operating links between AP MLD 302 and STA MLD 312 due to IDC emission unless their channels are sufficiently distant from each other. This interference primarily occurs between insufficiently separated channels in a band, for instance, two channels in the 5 GHz band with a very small channel gap. For example, as illustrated in FIG. 5, if Link1 342 between AP1 102-1 and STA1 112-1 and Link2 352 between AP2 102-2 and STA2 112-2 are insufficient in frequency, transmissions on these two links 342 and 352, such as the UL frame 344 on Link 1 342 and the DL frame 354 on Link2 352, may interfere with each other (which is called “IDC interference”). Usually, the severity of this IDC interference directly depends on how far apart the channels are on which these links operate. The closer the channels, the stronger the IDC interference. When the IDC interference is strong, no UL transmission is possible on Link1 342 if Link2 352 is busy with DL transmission, and no DL transmission is possible on Link2 352 if Link1 342 is busy with UL transmission.

Thus, when IDC interference occurs, it inevitably impacts ongoing transmissions and receptions over the affected links. If IDC occurs during reception, it reduces the signal-to-interference-plus-noise ratio (SINR), which often leads to packet losses.

Addressing the IDC issues for the STR mode in multi-link operation is one of the critical goals for the TGbn group and is crucial for improving the performance and reliability of the entire network. During an IDC event, an AP MLD 302 or a non-AP MLD 312 might be unable to communicate with the intended non-AP MLD 312 or AP MLD 302 using the previously agreed-upon parameters, and sometimes it may not be feasible to avoid IDC interference by selecting sufficiently distant operating channels across the multi-links. As a result, the STR operation mode requires methods for mitigating or reducing the IDC interference to ensure efficient operation with ultra-high reliability.

According to IEEE 802.11be (IEEE P802.11be/D5.0-35.3.16.3, 35.3.16.4), when a pair of links on which an MLD operates is a STR link pair, a STA that is affiliated with the STA MLD and that is operating on a link in that STR link pair shall access the wireless medium (WM; also called “channel”)) on that link by following the rules defined in 10.3 (DCF) and 10.23.2 (HCF contention based channel access (EDCA)) regardless of any activity occurring on the other link within that STR link pair, unless explicitly stated otherwise.

An AP/non-AP STA affiliated with an AP/non-AP MLD that has gained the right to initiate transmission of a frame of an access category (AC) on a link through the rules for obtaining an enhanced distributed channel access (EDCA) TXOP, as described in Section 10.23.2.4, Obtaining an EDCA TXOP, of IEEE P802.11-REVme/D5.0, may choose not to transmit any frame corresponding to that AC due to expected interference caused by the transmission at the AP/non-AP STA operating on one of the links of the NSTR link pair within the intended recipient non-AP/AP MLD.

An AP or non-AP STA affiliated with a MLD that has gained the right to initiate the transmission of a frame, as described in Section 10.23.2.4, Obtaining an EDCA TXOP, of IEEE P802.11-REVme/D5.0, for an AC but does not transmit any frame corresponding to that AC due to expected interference may invoke a backoff for the enhanced distributed channel access function (EDCAF) associated with that AC as allowed per Point (h) of Section 10.23.2.2, EDCA backoff procedure, of IEEE P802.11-REVme/D5.0.

If a non-AP STA that is affiliated with a non-AP MLD successfully obtains a TXOP on one link of one of its non-simultaneous transmit and receive (NSTR) link pairs before the target beacon transmission time (TBTT) of the other link, then it should end its TXOP before the other link TBTT if the other non-AP STA affiliated with the same non-AP MLD intends to receive the beacon frame scheduled at that TBTT on that link.

In IEEE P802.11be/D5.0-35.3.16.5, the IEEE 802.11be draft also specifies a mechanism to align the end time of PPDUs that are simultaneously transmitted to the non-AP STAs affiliated with a non-AP MLD operating on a pair of NSTR links for that MLD, which helps to reduce the chances of the occurrence of such self-interference among non-AP STAs affiliated with the same MLD.

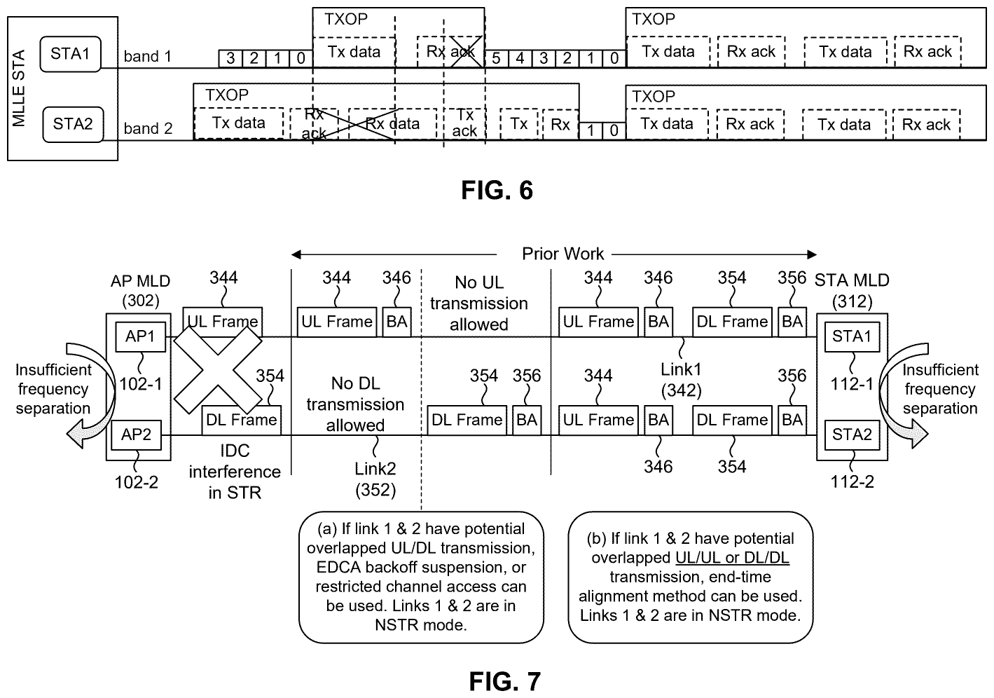

To mitigate IDC interference in multi-link operation, 802.11-19/1541r1, entitled “Performance aspects of multi-link operations with constraints,” to D. Akhmetov, et al., describes restricted channel access rules as shown in FIG. 6 (reproduced with reformatting). Before initiating a TXOP on one link, multi-link logical entity (MLLE) STA must check the status of the other interfering link.

The MLLE STA should refrain from initiating a TXOP on one link if the other interfering link/radio is in a receive state or if a response is expected on the other interfering link/radio.

If the other link/radio is in a transmit state, the STA should limit its own transmit duration to coincide with the end of the other transmissions. This end-time alignment ensures that transmissions on different channels finish simultaneously to minimize interference. It is desirable to synchronize TX/TX and RX/RX operations, that is, packet level and/or physical (PHY) level synchronization across links. It is clear that this approach supports an NSTR operation to mitigate the IDC interference.

In 802.11-20/0081r3, entitled “MLO-Synch-Transmission,” to M. Fischer et al., a MLD may operate under conditions that impose restrictions on TX and RX behavior. As shown in FIG. 7, for certain link channel combinations for affiliated AP/non-APs, simultaneous TX/RX might be restricted, which is a condition known as NSTR. An NSTR MLD should suspend the enhanced distributed channel access (EDCA) backoff countdown on a link when a transmission by the same NSTR MLD on another link prevents the assessment of the medium condition on this link within the receiver's required performance limit of minimum sensitivity. This technique is called EDCA backoff suspension. Furthermore, an NSTR MLD performing EDCA on a link where multi-link operation (MLO) synchronization rules are enabled should suspend the EDCA function if the start of a preamble is detected on another link of a set which is operating synchronously. This link is referred to as an EDCA backoff suspended link. The EDCA function should resume after the PHY Header LENGTH information has been decoded, or if the decoding process fails.

While the issue of IDC is addressed, it comes at the expense of reduced achievable throughput at the NSTR AP/non-AP MLDs with transmit/receive constraints. AP/non-AP MLDs are unable to transmit on one link and receive on another adjacent interfering link simultaneously due to potential IDC power leakage. Under certain conditions, multi-link operation may converge to a single link operation, which is not ideal.

There is also an increase in complexity, particularly in end-time alignment methods, due to the required synchronization of transmit and receive operations.

Furthermore, for time-sensitive applications, such as IoT communications and online gaming applications, the delay requirements are stringent. In such cases, applying restricted channel access or EDCA backoff suspension methods might not be feasible. This presents a significant disadvantage of the prior art.

In the following, various embodiments of a power-controlled multi-link STR operation method are disclosed. The power-controlled multi-link STR operation method uses a power-control method with awareness of IDC for multi-link STR operation. The power-controlled multi-link STR operation method also includes various signaling methods for effective power information exchange between STA MLD 312 and AP MLD 302.

In various embodiments, the power-controlled multi-link STR operation method provides a method to manage the IDC interference in multi-link STR operation, while retaining as much possible benefits and many inherent advantages of the STR mode, by adapting the transmission power values over all links based on the frequency gap between the affiliated STAs and the presence of the IDC interference. More specifically, by dynamically adjusting transmission power values, STR mode effectively manages IDC interference, thereby enabling efficient STR multi-link operations while maintaining minimal latency. Although this adaptive power management may result in a slight reduction in overall throughput, power-controlled STR mode still significantly outperforms NSTR methods, particularly in time-sensitive applications. The enhanced latency performance and interference management make STR mode highly advantageous for scenarios requiring stringent timing and reliability.

The power-controlled multi-link STR operation method may use any suitable signaling method for efficient power information exchange between AP MLD 302 and STA MLD 312.

For example, in some embodiments, the power-controlled multi-link STR operation method introduces Multi-Link Power Capability and Power Constraint elements to the multi-link operations in order to provide an IDC-aware multi-link power control.

In some embodiments, the power-controlled multi-link STR operation method may use an UHR Basic Multi-Link element to include the transmit power capabilities and constraints information for each link.

In some embodiments, if there is a need to update the local transmit power constraint for an affiliated STA 112, the power-controlled multi-link STR operation method may use an UHR Reconfiguration Multi-Link element to provide recommendation for multi-link reconfiguration to the STA MLD 312 to update the local transmit power constraint for the affiliated STA 112.

Thus, the transmission power on the interfering links may be adapted to values that minimize the adverse effects of IDC interference while maintaining the advantages of multi-link STR operation, which include maximizing throughput and minimizing latency (compared to NSTR methods), making it suitable for delay-sensitive applications.

In various embodiments, the power-controlled multi-link STR operation method may be used in various wireless communication systems and devices such as WI-FI® AP MLDs 302 and STA MLDs 312 with multi-link (such as multi-band and/or multi-channel) capability, for example, WI-FI® 8 MLDs 302 and STA MLDs 312. Accordingly, the power-controlled multi-link STR operation method may be suitable for the standardization of next generation of IEEE 802.11bn for MLO.

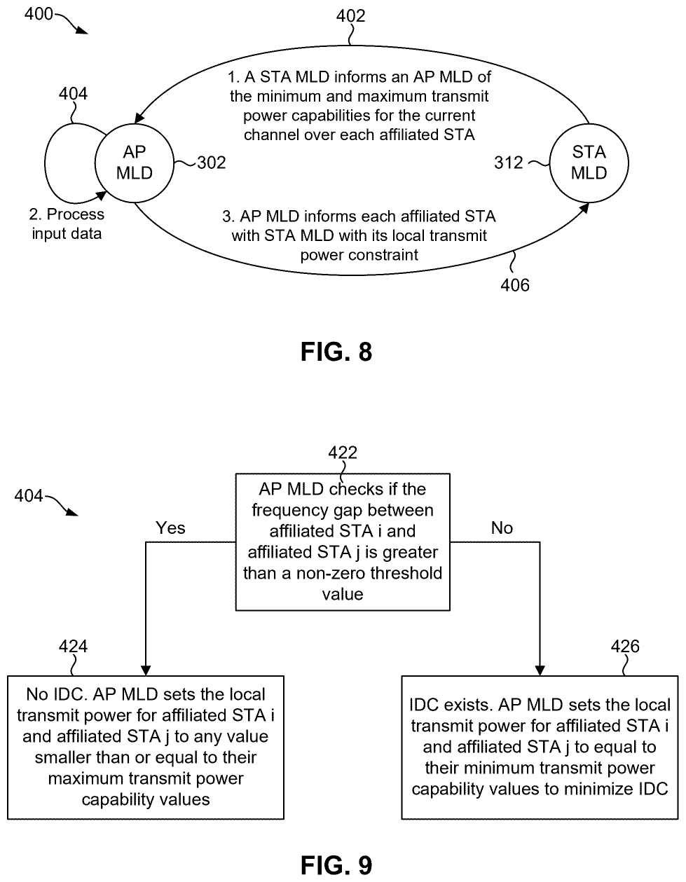

FIG. 8 is a schematic diagram showing the power-controlled multi-link STR operation method 400, according to some embodiments of this disclosure. In these embodiments, the power-controlled multi-link STR operation method 400 adapts the transmission power value to minimize the IDC interference in STR MLD.

As shown, a STA MLD 312 selects or otherwise determines a minimum transmit power capability for each affiliated STA 112 to ensure reliable communication, wherein various factors such as channel conditions, distance, device characteristics, and/or the like may be taken into account for making this determination. The STA MLD 312 also selects or otherwise determines a maximum transmit power capability based on, for example, the regulatory requirements and/or hardware device capabilities.

At step 402, when the STA MLD 312 is when associating or reassociating with an AP MLD 302, the STA MLD 312 informs the AP MLD 302 of the minimum and maximum transmit power capabilities for the current channel over each affiliated STA 112 using the Multi-Link Power Capability element in a (re) association request frame (that is, an association request frame or a reassociation request frame).

At step 404, the AP MLD 302 uses the minimum and maximum transmit power capabilities of the affiliated STAs 112 of the STA MLD 312 to determine the local maximum transmit power constraint for each affiliated STA 112 based on the frequency gap between the affiliated STAs 112 and the presence of the IDC interference.

At step 406, the AP MLD 302 informs each affiliated STA 112 with its local maximum transmit power constraint using the Multi-Link Power Constraint element in a (re) association response frame.

FIG. 9 is a schematic diagram showing the detail of step 404 of the power-controlled multi-link STR operation method 400, according to some embodiments of this disclosure.

At step 422, the AP MLD 302 checks if the frequency gap between the i-th affiliated STA 112-i of the STA MLD 312 and the j-th affiliated STA 112-j of the STA MLD 312 is greater than a predefined or predetermined non-zero threshold value.

If the frequency gap between the two affiliated STAs 112-i and 112-j is greater than a predefined or predetermined non-zero threshold value, there would be no IDC, and the AP MLD 302 sets the local power constraints for the i-th affiliated STA 112-i and the j-th affiliated STA 112-j to any values between their minimum transmit power capability values and their maximum transmit power capability values (step 424).

In these embodiments, the local power constraint for an affiliated STA 112 is an upper limit of the transmission power that the affiliated STA 112 shall use. In other words, the affiliated STA 112 may set its transmission power to any value between its minimum transmit power capability value and its local power constraint.

At step 424, the AP MLD 302 may set the local power constraints for the i-th affiliated STA 112-i and the j-th affiliated STA 112-j to their maximum transmit power capability values if there are no other interference sources in the network. Otherwise, the AP MLD 302 may set the local power constraints for the i-th affiliated STA 112-i and the j-th affiliated STA 112-j to values greater than or equal to their minimum transmit power capability values, and smaller than or equal to their maximum transmit power capability values, based on the presence of other interference sources or for power consumption savings.

If, at step 422, the AP MLD 302 determines that the frequency gap between the two affiliated STAs 112-i and 112-j is greater than a predefined or predetermined non-zero threshold value, then, IDC may exist, and the AP MLD 302 sets the local transmit powers for the i-th affiliated STA 112-i and the j-th affiliated STA 112-j to their minimum transmit power capability values to minimize IDC.

As those skilled in the art understand, in IEEE 802.11, management frames such as (re) association request frames are used by AP/non-AP for performing supervisory functions such as joining and leaving wireless networks and moving associations from one AP to another AP. A management frame generally comprises a plurality of information elements.

In some embodiments, the power-controlled multi-link STR operation method 400 introduces and uses Multi-Link Power Capability element and Multi-Link Power Constraint element of a (re) association request frame for indicating links to which the power control operation applies.

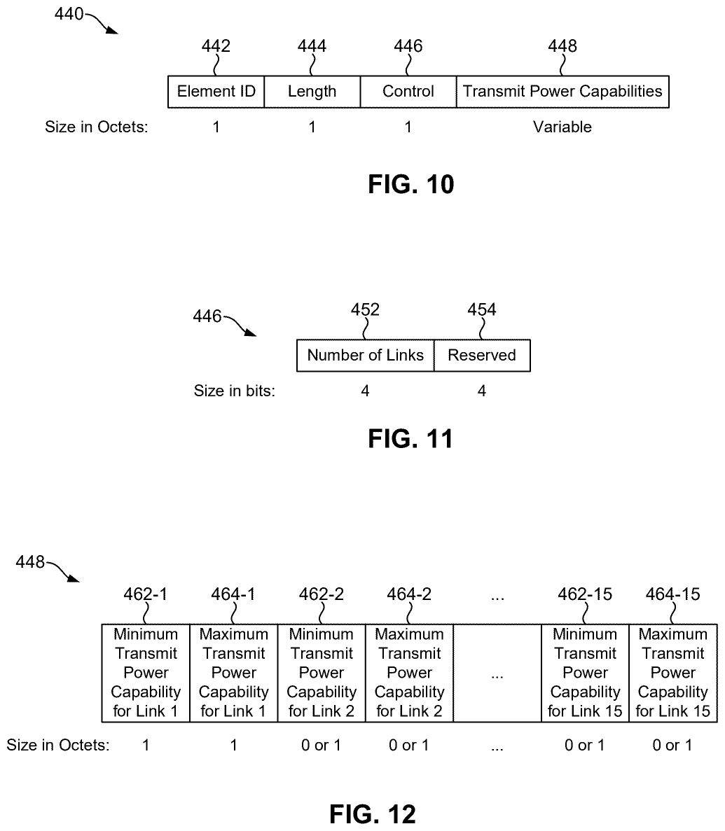

FIG. 10 shows the structure of the Power Capability element 440 (denoted “Multi-Link Power Capability element”) of the (re) association request frame (sent from the STA MLD 312 to the AP MLD 302) for multi-link operations. As shown, the Power Capability element 440 comprises a one-byte Element ID 442, a one-byte Length field 444, a one-byte Control field 446, and a Transmit Power Capabilities field 448 of a variable length. As a comparison, the Power Capability element of the prior-art (re) association request frame is generally for single-link operations, and comprises a one-byte Element ID, a one-byte Length field, a one-byte Minimum Transmit Power field, and a one-byte Maximum Transmit Power field. Therefore, the Power Capability element of the prior-art (re) association request frame is not suitable for multi-link operations.

FIG. 11 shows the structure of the Control field 446 of the Multi-Link Power Capability element 440. In these embodiments, the Control field 446 comprises a four-bit Number of Links subfield 452. The other four bits 454 are reserved or not used.

The Number of Links subfield 452 indicates the number of links specified in the Transmit Power Capabilities field 448. Table 1 provides the meaning of the Number of Links subfield 452. For example, the Number of Links subfield 452 set to value zero (0) indicates that the Transmit Power Capabilities field 448 only specifies the minimum and maximum transmit power capabilities of one link (that is, Link 1). As another example, the Number of Links subfield 452 set to value 14 indicates that the Transmit Power Capabilities field 448 specifies the minimum and maximum transmit power capabilities of 15 links (that is, Link 1 to Link 15).

TABLE 1
MEANING OF THE NUMBER OF LINKS SUBFIELD
IN MULTI-LINK POWER CAPABILITY ELEMENT.

| Value | Subfields Present in the Transmit Power Capabilities Field 448 |
|---|---|
| 0 | Minimum Transmit Power Capability for Link 1 |
| | Maximum Transmit Power Capability for Link 1 |
| 1 | Minimum Transmit Power Capability for Link 1 |
| | Maximum Transmit Power Capability for Link 1 |
| | Minimum Transmit Power Capability for Link 2 |
| | Maximum Transmit Power Capability for Link 2 |
| . . . | . . . |
| 14 | Minimum Transmit Power Capability for Link 1 |
| | Maximum Transmit Power Capability for Link 1 |
| | . . . |
| | Minimum Transmit Power Capability for Link 15 |
| | Maximum Transmit Power Capability for Link 15 |
| 15 | Reserved |

FIG. 12 is a schematic diagram showing the structure of the Transmit Power Capabilities field 448 of the (re) association request frame, which in these embodiments comprises one or more byte-pairs for one or more links, wherein each byte-pair comprises a one-byte subfield 462 indicating the minimum transmit power capability and another one-byte subfield 464 indicating the maximum transmit power capability of the respective link. Thus, the Transmit Power Capabilities field 448 in these embodiments may be used for specifying the minimum and maximum transmit power capabilities of a minimum of one link (wherein the Transmit Power Capabilities field 448 has a length of two bytes) and a maximum of 15 links (wherein the Transmit Power Capabilities field 448 has a length of 30 bytes).

In these embodiments, the Minimum Transmit Power Capability subfield 462 and Maximum Transmit Power Capability subfield 464 for each link are set to the nominal minimum and maximum transmit powers, respectively, with which the STA is capable of transmitting in the current channel, with a tolerance of, for example, +5 decibels (dB). For example, each of the Minimum Transmit Power Capability subfield 462 and Maximum Transmit Power Capability subfield 464 is coded as a two's complement signed integer in units of decibels relative to one (1) milliwatts (mW).

Herein, “nominal” refers to the standard or expected values of the minimum and maximum transmit powers that the affiliated STA 112 is capable of transmitting on the current channel. These values are defined under typical conditions and are subject to a specified tolerance.

For example, “nominal minimum power” refers to the standard or usual lowest power level the affiliated STA 112 can transmit at in the given channel. It may not represent the absolute minimum power possible, and rather is the recommended or most common starting point.

Similarly, “nominal maximum power” refers to the standard or usual highest power level the affiliated STA 112 can transmit at in the channel. It may not be the absolute maximum power possible, and rather is the recommended limit for that specific channel.

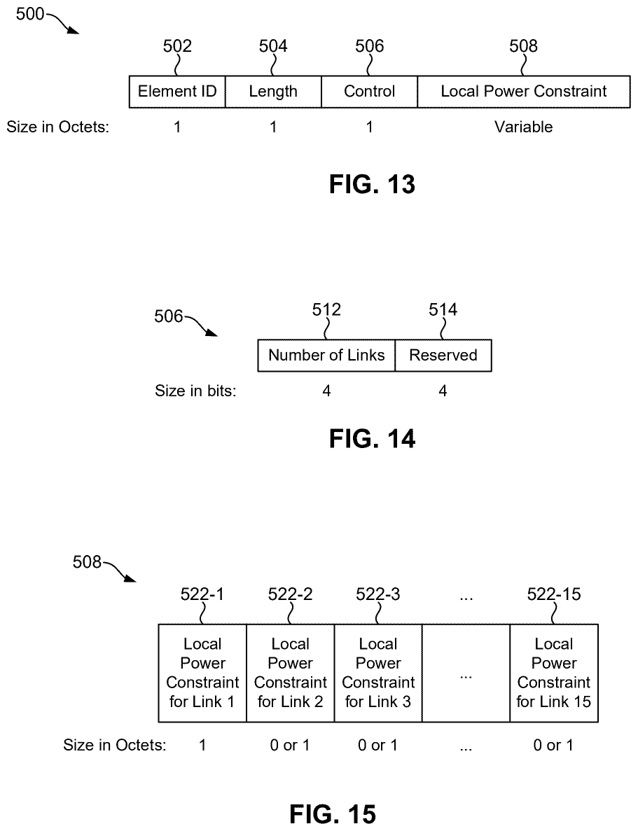

FIG. 13 shows the structure of the Power Constraint element 500 (denoted “Multi-Link Power Constraint element”) of a (re) association response frame (sent from AP MLD 302 to the STA MLD 312) for multi-link operations, which is generally for single-link operations, and comprises a one-byte Element ID 502, a one-byte Length field 504, a one-byte Control field 506, and a Local Power Constraint field 508 of a variable length.

FIG. 14 shows the structure of the Control field 506 of The Multi-Link Power Constraint element 500. In these embodiments, the Control field 506 comprises a four-bit Number of Links subfield 512. The other four bits 512 are reserved or not used.

The Number of Links subfield 512 indicates the number of links specified in the Local Power Constraint field 508. Table 2 provides the meaning of the Number of Links subfield 512. For example, the Number of Links subfield 512 set to value zero (0) indicates that the Local Power Constraint field 508 only specifies the local power constraint of one link (that is, Link 1). As another example, the Number of Links subfield 512 set to value 14 indicates that the Local Power Constraint field 508 specifies the local power constraints of 15 links (that is, Link 1 to Link 15).

TABLE 2
MEANING OF THE NUMBER OF LINKS SUBFIELD
IN POWER CONSTRAINT ELEMENT.

| Value | Subfields Present in the Local Power Constraint Field 508 |
|---|---|
| 0 | Local Power Constraint for Link 1 |
| 1 | Local Power Constraint for Link 1 |
| | Local Power Constraint for Link 2 |
| 2 | Local Power Constraint for Link 1 |
| | Local Power Constraint for Link 2 |
| | Local Power Constraint for Link 3 |
| . . . | . . . |
| 14 | Local Power Constraint for Link 1 |
| | Local Power Constraint for Link 2 |
| | . . . |
| | Local Power Constraint for Link 15 |
| 15 | Reserved |

FIG. 15 is a schematic diagram showing the structure of the Local Power Constraint field 508, which in these embodiments comprises one or more one-byte subfields 522 each for indicating the local power constraint of a respective link. Thus, the Local Power Constraint field 508 in these embodiments may be used for specifying the local power constraint of a minimum of one link (wherein the Local Power Constraint field 508 has a length of one byte) and a maximum of 15 links (wherein the Local Power Constraint field 508 has a length of 15 bytes).

In these embodiments, the Local Power Constraint subfield 522 for each link is coded as a two's complement signed integer in units of decibels relative to one (1) mW.

In some embodiments, the power-controlled multi-link STR operation method 400 uses a UHR Basic Multi-Link element of the (re) association request/response frame for power information exchange in MLO. In these embodiments, a non-AP STA 112 affiliated with a non-AP MLD 312 that initiates a multi-link (ML) (re) setup with an AP MLD 302 transmits a (re) association request frame to the AP MLD 302, wherein the (re) association request frame comprises a UHR Basic Multi-Link element for indicating the power capabilities of the links (or affiliated STAs 112).

The AP MLD 302 then uses the minimum and maximum transmit power capability of the affiliated STAs 112 of the STA MLD 312 to determine the local maximum transmit power constraint for each affiliated STA 112 based on the frequency gap between the affiliated STAs 112 and the presence of the IDC interference. Then, the AP MLD 302 responds to the (re) association request frame by transmitting a (re) association response frame to the STA MLD 312, wherein the (re) association response frame comprises a UHR Basic Multi-Link element for indicating the local power constraints for the link (or affiliated STAs 112).

As those skilled in the art understand, the multi-link element of the prior-art (re) association request frame for multi-link STR operations in IEEE 802.11be comprises an Element ID field, a Length field, an Element ID Extension field, a Control field, an MLD Common Information field, and a Per-Interface Information field, wherein the Control field comprises a Type subfield and a Presence Bitmap subfield.

Table 3 lists the Type subfield encoding of prior-art IEEE P802.11be/D5.0-9.4.2.312.1.

TABLE 3
TYPE SUBFIELD (3 BITS) ENCODING OF IEEE P802.11BE.

| Type | Multi-Link | |
|---|---|---|
| Subfield | Element | |
| Value | Variant Name | Variant Specific Format |
| 0 | Basic | See 9.4.2.312.2 (Basic Multi-Link element) |
| 1 | Probe Request | See 9.4.2.312.3 (Probe Request Multi-Link |
| | | element) |
| 2 | Reconfiguration | See 9.4.2.312.4 (Reconfiguration Multi- |
| | | Link element) |
| 3 | TDLS | See 9.4.2.312.5 (TDLS Multi-Link element) |
| 4 | Priority Access | See 9.4.2.312.6 (EPCS Priority Access |
| | | Multi-Link element) |
| 5-7 | Reserved | |

As can be seen, the 3-bit Type subfield of the Control field defines five (5) variants of the multi-link element corresponding to values ranging from 0 to 4. The values from 5 to 7 are reserved (that is, unused).

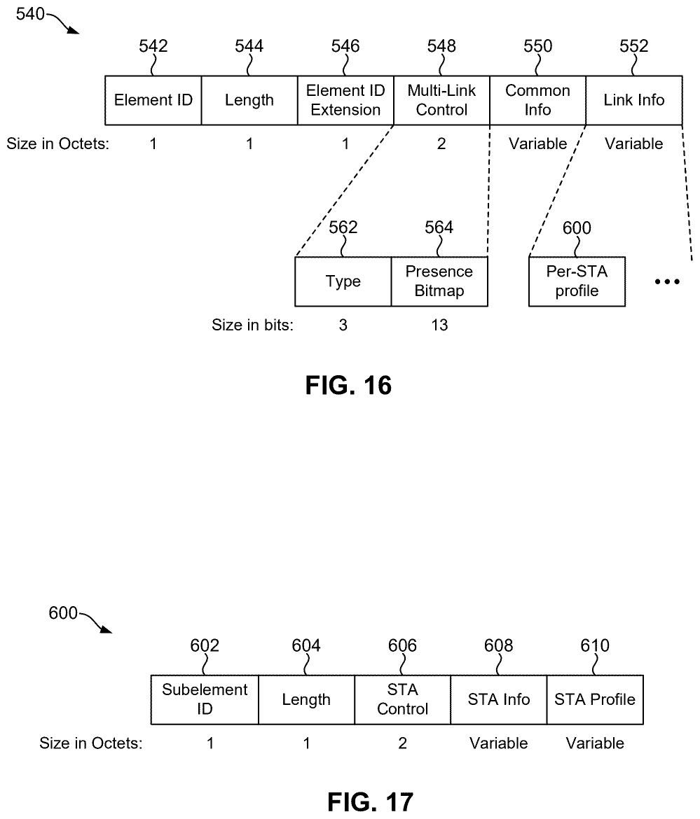

In these embodiments, the UHR Basic Multi-Link element of the (re) association request frame has a structure similar to that of the multi-link element of the prior-art (re) association request frame but with modifications. FIG. 16 shows the structure of the UHR Basic Multi-Link element 540 in these embodiments.

As shown, the UHR Basic Multi-Link element 540 of the (re) association request frame comprises a one-byte Element ID field 542, a one-byte Length field 544, a one-byte Element ID Extension field 546, a two-byte Multi-Link Control field 548, a Common Information field 550 of a variable length, and a Link Info field 552 of a variable length.

The Element ID field 542, Length field 544, Element ID Extension field 546, and Common Information field 550 of the UHR Basic Multi-Link element 540 in these embodiments are the same as the Element ID field, Length field, Element ID Extension field, and MLD Common Information field of the prior-art multi-link element, respectively. The Multi-Link Control field 548 of the UHR Basic Multi-Link element 540 is similar to the Control field of the above-described prior-art multi-link element, and comprises a Type subfield 562 and a Presence Bitmap subfield 564.

However, in these embodiments, the Multi-Link Control field 548 further defines two new variants of the multi-link element. More specifically, the Multi-Link Control field 548 further defines value 5 to represent the UHR Basic Multi-Link element variant and the value 6 to represent the UHR Reconfiguring Multi-Link element variant. Table 4 lists the Type subfield 562 encoding in these embodiments, wherein multi-link element variants for values 0 to 4 are the same as the prior-art shown in Table 3 and those for values 5 and 6 are the two new variants.

TABLE 4
TYPE SUBFIELD (3 BITS) ENCODING USED BY THE POWER-
CONTROLLED MULTI-LINK STR OPERATION METHOD.

| Type Subfield | |
|---|---|
| Value | Multi-Link Element Variant Name |
| 0 | Basic |
| 1 | Probe Request |
| 2 | Reconfiguration |
| 3 | TDLS |
| 4 | Priority Access |
| 5 | UHR Basic |
| 6 | UHR Reconfiguration |
| 7 | Reserved |

Referring back to FIG. 16, the Link Info field 552 comprises one or more Per-STA Profile subelements 600 of the newly defined UHR Basic and Reconfiguration Multi-Link element variants (types 5 and 6), for the per-link power capabilities and constraint information.

As described above, setting the value of the Type subfield 562 of the Multi-Link Control field 548 to five (5) indicating the UHR Basic Multi-Link variant, wherein all fields in the UHR Basic Multi-Link format follows the same format as in the type 0 (Basic Multi-Link element), except the STA Control and STA Info subfields within the Per-STA Profile subelement.

FIG. 17 is a schematic diagram showing the structure of the Per-STA Profile subelement 600 of the UHR Basic Multi-Link element, which comprises a one-byte Subelement ID field 602, a one-byte Length field 604, a two-byte STA Control field 606, a STA Info field 608 of a variable length, and a STA Profile field 610 of a variable length. The Subelement ID field 602, Length field 604, and STA Profile field 610 are the same as those of the prior-art Per-STA Profile subelement, respectively. The STA Control field 606 and STA Info field 608 are modified from the prior art (see below).

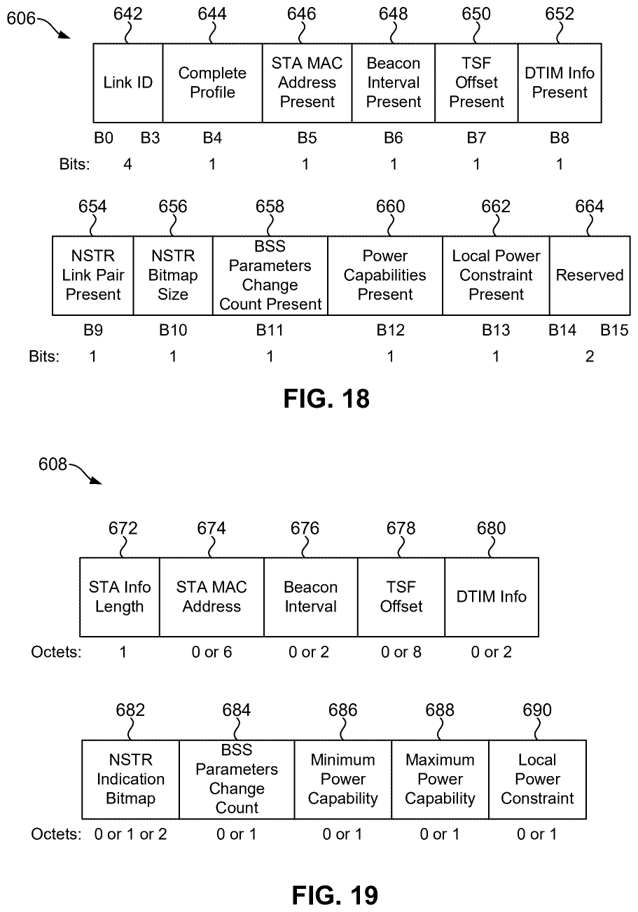

FIG. 18 is a schematic diagram showing the structure of the STA Control field 606 of the Per-STA Profile subelement 600 of the UHR Basic Multi-Link element. As shown, the STA Control field 606 comprises a four-bit Link ID subfield 642, a one-bit Complete Profile subfield 644, a one-bit STA MAC Address Present subfield 646, a one-bit Beacon Interval Present subfield 648, a one-bit Timing Synchronization Function (TSF) Offset Present subfield 650, a one-bit Delivery Traffic Indication Map (DTIM) Info Present subfield 652, a one-bit NSTR Link Pair Present subfield 654, a one-bit NSTR Bitmap Size subfield 656, a one-bit Basic Service Set (BSS) Parameters Change Count Present subfield 658, a one-bit Power Capabilities Present subfield 660 (indicating that minimum and maximum power capabilities are present in the STA information (that is, the STA Info field 608)), a one-bit Local Power Constraint Present subfield 662 (indicating that local power constraint is present in the STA Info field 608), and a two-bit reserved subfield 664.

The subfields 642 to 658 are the same as those of the prior-art STA Control field of the Per-STA Profile subelement of the Basic Multi-Link element. The subfields 660 to 664 are new subfields used by the power-controlled multi-link STR operation method 400, allowing the inclusion of necessary power information for each link during the MLO (re) setup process.

A STA MLD 312 may set the Power Capabilities Present subfield 660 to one (1) if the Minimum and Maximum Power Capabilities subfields 686 and 688 (see FIG. 19) are present in the STA Info field 608; otherwise, the Power Capabilities Present subfield 660 is set to zero (0).

An AP MLD 302 may set the Local Power Constraint Present subfield 662 to one (1) if the Local Power Constraint subfield 690 (see FIG. 19) is present in the STA Info field 608; otherwise, the Local Power Constraint Present subfield is set to zero (0).

FIG. 19 is a schematic diagram showing the structure of the STA Info field 608 of the Per-STA Profile subelement 600 of the UHR Basic Multi-Link element. As shown, the STA Info field 608 comprises a one-byte STA Info Length subfield 672, an optional six-byte STA MAC Address subfield 674, an optional two-byte Beacon Interval subfield 676, an optional eight-byte TSF Offset subfield 678, an optional two-byte DTIM Info subfield 680, an optional one-byte or two-byte NSTR Indication Bitmap subfield 682, an optional one-byte BSS Parameters Change Count subfield 684, an optional one-byte Minimum Power Capability subfield 686, an optional one-byte Maximum Power Capability subfield 688, and an optional one-byte Local Power Constraint subfield 690. As will be described in more detail below, the Minimum Power Capability subfield 686 and Maximum Power Capability subfield 688 are used in the (re) association request frame sent from the STA MLD 312 to the AP MLD 302, and the Local Power Constraint subfield 690 is used in the (re) association response frame sent from the AP MLD 302 to the STA MLD 312 in response to a (re) association request frame.

In this structure, “optional” means that the STA Info field 608 may or may not include the optional subfields 674 to 690 depending on the situation, which is indicated by the STA Control field 606.

For example, value one (1) of the STA MAC Address Present subfield 646, Beacon Interval Present subfield 648, TSF Offset Present subfield 650, DTIM Info Present subfield 652, NSTR Link Pair Present subfield 654, or BSS Parameters Change Count Present subfield 658 of the STA Control field 606 indicates that the STA MAC Address subfield 674, Beacon Interval subfield 676, TSF Offset subfield 678, DTIM Info subfield 680, NSTR Indication Bitmap subfield 682, or BSS Parameters Change Count subfield 684, respectively, is included in the STA Info field 608.

Value zero (0) of the STA MAC Address Present subfield 646, Beacon Interval Present subfield 648, TSF Offset Present subfield 650, DTIM Info Present subfield 652, NSTR Link Pair Present subfield 654, or BSS Parameters Change Count Present subfield 658 of the STA Control field 606 indicates that the STA MAC Address subfield 674, Beacon Interval subfield 676, TSF Offset subfield 678, DTIM Info subfield 680, NSTR Indication Bitmap subfield 682, or BSS Parameters Change Count subfield 684, respectively, is not included in the STA Info field 608.

The NSTR Bitmap Size subfield 656 of the STA Control field 606 indicates the size (that is, one byte or two bytes) of the NSTR Indication Bitmap subfield 682 of the STA Info field 608.

Value one (1) of the Power Capabilities Present subfield 660 of the STA Control field 606 indicates that the Minimum Power Capability subfield 686 and Maximum Power Capability subfield 688 are included in the STA Info field 608. Value zero (0) of the Power Capabilities Present subfield 660 of the STA Control field 606 indicates that the Minimum Power Capability subfield 686 and Maximum Power Capability subfield 688 are not included in the STA Info field 608.

Value one (1) of the Local Power Constraint Present subfield 662 of the STA Control field 606 indicates that the Local Power Constraint subfield 690 is included in the STA Info field 608. Value zero (0) of the Local Power Constraint Present subfield 662 of the STA Control field 606 indicates that the Local Power Constraint subfield 690 is not included in the STA Info field 608.

In the structure of the STA Info field 608 shown in FIG. 19, the subfields 672 to 684 are the same as those of the prior-art STA Info field of the Per-STA Profile subelement of the Basic Multi-Link element. The subfields 686 to 690 are new subfields used by the power-controlled multi-link STR operation method 400, allowing the inclusion of necessary power information for each link during the MLO (re) setup process.

More specifically, the Minimum and Maximum Transmit Power Capability subfields 686 and 688 are set to the nominal minimum and maximum transmit powers, respectively, with which the STA 112 is capable of transmitting in the current channel, with a tolerance of, for example, +5 dB. Each of these subfields 686 and 688 is coded as a two's complement signed integer in units of decibels relative to one (1) mW.

The Local Power Constraint subfield 690 is coded as a two's complement signed integer in units of decibels relative to one (1) mW.

In some embodiments, a receiving AP/non-AP MLD 302 or 312 determines the end of the STA Info field 608 based on the STA Info Length subfield 672 of the STA Info field 608 in the Per-STA Profile subelement.

As described above, the UHR Basic Multi-Link element may be used in the (re) association request frame and the (re) association response frame.

For example, a non-AP MLD 312 may send a (re) association request frame to an AP MLD 302. The (re) association request frame comprises a UHR Basic Multi-Link element 540. The Link Info field 552 of the UHR Basic Multi-Link element 540 comprises a plurality of Per-STA Profile subelements 600, each for indicating the power capability of a respective link (or affiliated STA 112).

More specifically, in each Per-STA Profile subelement 600, the non-AP MLD 312 sets the Power Capabilities Present subfield 660 of the STA Control field 606 of the Per-STA Profile subelement 600 to one (1) to indicate that the Minimum and Maximum Power Capabilities subfields 686 and 688 are present in the STA Info field 608 of the Per-STA Profile subelement 600 of the UHR Basic Multi-Link element 540. Moreover, the non-AP MLD 312 sets the Local Power Constraint Present subfield 662 of the STA Control field 606 of the Per-STA Profile subelement 600 to zero (0) to indicate that the local power constraint 690 is not included in the STA Info field 608 of the Per-STA Profile subelement 600 of the UHR Basic Multi-Link element 540 of the (re) association request frame.

The AP MLD 302 receives the (re) association request frame from the non-AP MLD 312. After processing the input data and checking for the presence of IDC, the AP MLD 302 sends to the non-AP MLD 312 a (re) association response frame.

The (re) association response frame comprises a UHR Basic Multi-Link element 540. The Link Info field 552 of the UHR Basic Multi-Link element 540 comprises a plurality of Per-STA Profile subelements 600, each for indicating the power capability of a respective link (or affiliated STA 112).

In each Per-STA Profile subelement 600, the AP MLD 302 sets the Local Power Constraint Present subfield 662 of the STA Control field 606 to one (1) to indicate that the Local Power Constraint subfield 690 is present in the STA Info field 608, and sets the Power Capabilities Present subfield 660 of the STA Control field 606 to zero (0) to indicate that the Minimum and Maximum Transmit Power Capability fields 686 and 688 are not included in the STA Info field 608 of Per-STA Profile subelement 600 of the UHR Basic Multi-Link element 540 in the (re) association response frame.

In some embodiments, the power-controlled multi-link STR operation method 400 uses the UHR Reconfiguration Multi-Link element (type 6) to update the power capability information and/or local transmit power.

In some embodiments, the local transmit power constraint per affiliated STA 112 may be applied all the time. In some other embodiments, the local transmit power constraint per affiliated STA 112 may be applied within a specific service period and signaling is used for notifying the updated local transmit power constraint per affiliated STA 112 value (to update the local transmit power constraint per affiliated STA 112 according to the changes of the networks, for example, link removal or adding).

In some embodiments, the local transmit power constraint may need to be updated when an interfering link is added (or activated) or removed (or disabled), as outlined in section 35.3.6.4, Link reconfiguration to the ML setup of IEEE P802.11be/D5.0-35.3.6.4.

If there is a need to update the local transmit power constraint for an affiliated STA 112, a UHR Reconfiguration Multi-Link element is used to provide recommendation for ML reconfiguration to the one or more non-AP MLD(s) 312 associated with the AP MLD 302.

More specifically, an AP MLD 302 may recommend updating the local power constraint for the affiliated STA(s) 112 of a non-AP MLD 312 impacted by changes in the network (for example, the affiliated STAs 112 experiencing IDC interferences or the affiliated STAs 112 whose IDC interferences have disappeared), by sending a link reconfiguration notify frame that contains an UHR Reconfiguration Multi-Link element to those affiliated STAs 112, wherein the UHR Reconfiguration Multi-Link element includes the updated local power constraint information for affiliated STA(s) 112 in the Link Info field.

In response to a link reconfiguration notify frame, a non-AP MLD 312 may initiate ML reconfiguration to its ML setup by following the procedure defined in IEEE P802.11be/D5.0-35.3.6.4, Link reconfiguration to the ML setup.

In some embodiments, the minimum and maximum transmit power capability values may need to be updated when the channel conditions varies or the distance between the non-AP MLD 312 and AP MLD 302 changes, to ensure reliable communication.

If there is a need to update the transmit power capability values for an affiliated STA 112, a UHR Reconfiguration Multi-Link element is used to request a ML reconfiguration update for the one or more non-AP MLD(s) 312 associated with the AP MLD 302. The UHR Reconfiguration Multi-Link element includes a Per-STA Profile subelement for each affiliated non-AP STA 112 that the non-AP MLD 312 is requesting to update their respective transmit power capability values. The Reconfiguration Multi-Link element does not include any other Per-STA Profile subelements.

More specifically, a non-AP MLD 312 may request updating the power capability values for a certain affiliated STA 112 of a non-AP MLD 312 by sending a link reconfiguration request frame that contains an UHR Reconfiguration Multi-Link element to the AP MLD 302, wherein the UHR Reconfiguration Multi-Link element includes the updated transmit power capability values for affiliated STA(s) 112 in the Link Info field.

In response to the link reconfiguration request frame, an AP MLD 302 may update the local transmit power constraint for affiliated STA(s) 112 and respond with link reconfiguration response frame on the same link where the corresponding link reconfiguration request frame was received. After receiving the link reconfiguration response frame, the non-AP MLD 312 initiates ML reconfiguration to its ML setup by following the procedure defined in IEEE P802.11be/D5.0-35.3.6.4, Link reconfiguration to the ML setup.

As described above, setting the value of the Type subfield 562 of the Multi-Link Control field 548 to six (6) indicates the UHR Reconfiguration Multi-Link variant (see Table 4), wherein all fields in the UHR Reconfiguration Multi-Link format follows the same format as in the type 2 (Reconfiguration Multi-Link element), except the STA control and STA info subfields within the Per-STA Profile subelement. As will be described in more detail below, the STA control and STA Info fields of the Per-STA Profile subelement format of the UHR Reconfiguration Multi-Link element include power constraint present, power capabilities present, and their updated values subfields, respectively, thereby allowing the inclusion of necessary updated power information for each affiliated STA 112.

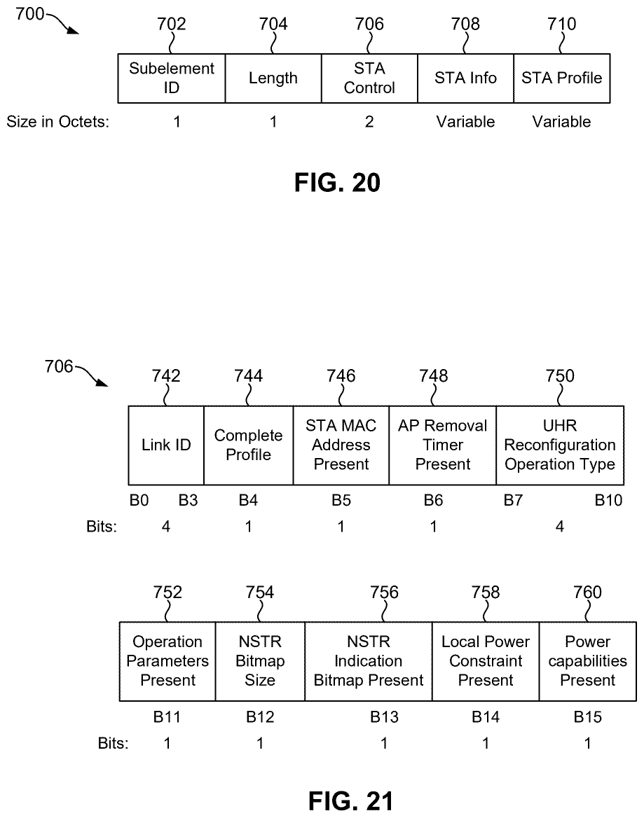

FIG. 20 is a schematic diagram showing the structure of the Per-STA Profile subelement 700 of the UHR Reconfiguration Multi-Link element. As can be seen, the structure of the Per-STA Profile subelement 700 of the UHR Reconfiguration Multi-Link element is similar to that of the Per-STA Profile subelement 600 of the UHR Basic Multi-Link element shown in FIG. 17, and comprises a one-byte Subelement ID field 702, a one-byte Length field 704, a two-byte STA Control field 706, a STA Info field 708 of a variable length, and a STA Profile field 710 of a variable length.

FIG. 21 is a schematic diagram showing the structure of the STA Control field 706 of the Per-STA Profile subelement 700 of the UHR Reconfiguration Multi-Link element. As shown, the STA Control field 706 comprises a four-bit Link ID subfield 742, a one-bit Complete Profile subfield 744, a one-bit STA MAC Address Present subfield 746, a one-bit AP Removal Timer Present subfield 748, a four-bit UHR Reconfiguration Operation Type subfield 750, a one-bit Operation Parameters Present subfield 752, a one-bit NSTR Bitmap Size subfield 754, a one-bit NSTR Indication Bitmap Present subfield 756, a one-bit Local Power Constraint Present subfield 758, and a one-bit Power Capabilities Present subfield 760.

The Link ID subfield 742, Complete Profile subfield 744, STA MAC Address Present subfield 746, AP Removal Timer Present subfield 748, Operation Parameters Present subfield 752, NSTR Bitmap Size subfield 754, and NSTR Indication Bitmap Present subfield 756 are the same as those in the prior-art UHR Reconfiguration Multi-Link element.

The UHR Reconfiguration Operation Type subfield 750 is expanded from the Reconfiguration Operation Type subfield encoding in prior art as shown in Table 5 below (reproduced from IEEE P802.11be/D5.0-9.4.2.312.4, Table 9-4041).

TABLE 5
RECONFIGURATION OPERATION TYPE SUBFIELD ENCODING
IN IEEE P802.11BE/D5.0 - 9.4.2.312.4.

| Value | Name |
|---|---|
| 0 | AP Removal |
| 1 | Operation Parameter Update |
| 2 | Add Link |
| 3 | Delete Link |
| 4 | NSTR Status Update |
| 5-15 | Reserved |

In these embodiments, the values of the UHR Reconfiguration Operation Type subfield 750 is listed in Table 6 below, wherein value five (5) is defined for indicating local power update.

TABLE 6
UHR RECONFIGURATION OPERATION
TYPE SUBFIELD ENCODING.

| Value | Name |
|---|---|
| 0 | AP Removal |
| 1 | Operation Parameter Update |
| 2 | Add Link |
| 3 | Delete Link |
| 4 | NSTR Status Update |
| 5 | Power Update |
| 6-15 | Reserved |

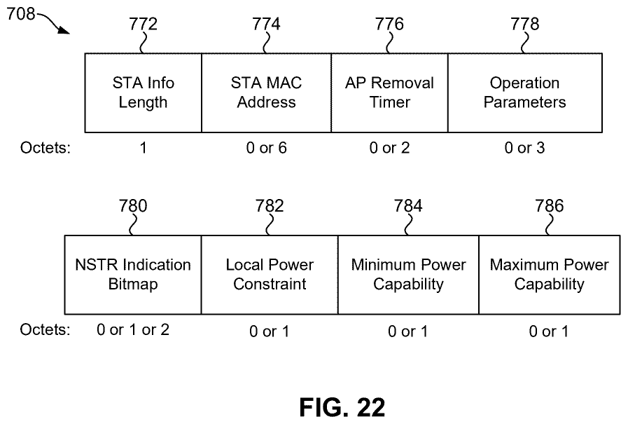

Referring back to FIG. 21, the Local Power Constraint Present subfield 758 and Power Capabilities Present subfield 760 are new subfields introduced in these embodiments, wherein an AP MLD 302 may set the Local Power Constraint Present subfield to one (1) if the Local Power Constraint subfield 782 (see FIG. 22) is present in the STA Info field 708, and may set to zero (0) if the Local Power Constraint subfield 782 is not included in the STA Info field 708. Also, non-AP MLD 312 may set the Power Capabilities Present subfield 760 to one (1) if the Minimum and Maximum Power Capabilities subfields 784 and 786 (see FIG. 22) are present in the STA Info field 708, and may set to zero (0) if the Minimum and Maximum Power Capabilities subfields are not included in the STA Info field 708,

FIG. 22 is a schematic diagram showing the structure of the STA Info field 708 of the Per-STA Profile subelement 700 of the UHR Reconfiguration Multi-Link element. As shown, the STA Info field 708 comprises a one-byte STA Info Length subfield 772, an optional six-byte STA MAC Address subfield 774, an optional two-byte AP Removal Timer subfield 776, an optional three-byte Operation Parameters subfield 778, an optional one-byte or two-byte NSTR Indication Bitmap subfield 780, an optional one-byte Local Power Constraint subfield 782, an optional one-byte Minimum Power Capability subfield 784, and an optional one-byte Maximum Power Capability subfield 786.

In this structure, “optional” means that the STA Info field 708 may or may not include the optional subfields 774 to 782 depending on the situation, which is indicated by the STA Control field 706.

For example, value one (1) of the STA MAC Address Present subfield 746, AP Removal Timer Present subfield 748, Operation Parameters Present subfield 752, NSTR Indication Bitmap Present subfield 756, or Local Power Constraint Present subfield 758 of the STA Control field 706 indicates that the STA MAC Address subfield 774, AP Removal Timer subfield 776, Operation Parameters subfield 778, NSTR Indication Bitmap subfield 780, or Local Power Constraint subfield 782, respectively, is included in the STA Info field 608.

Value zero (0) of the STA MAC Address Present subfield 746, AP Removal Timer Present subfield 748, Operation Parameters Present subfield 752, NSTR Indication Bitmap Present subfield 756, or Local Power Constraint Present subfield 758 of the STA Control field 706 indicates that the STA MAC Address subfield 774, AP Removal Timer subfield 776, Operation Parameters subfield 778, NSTR Indication Bitmap subfield 780, or Local Power Constraint subfield 782, respectively, is not included in the STA Info field 608.

The NSTR Bitmap Size subfield 754 of the STA Control field 706 indicates the size (that is, one byte or two bytes) of the NSTR Indication Bitmap subfield 780 of the STA Info field 708.

In the structure of the STA Info field 708 shown in FIG. 22, the subfields 772 to 780 are the same as those of the prior-art STA Info field of the Per-STA Profile subelement of the Reconfiguration Multi-Link element. The Local Power Constraint subfield 782, the Minimum Power Capability subfield 784, and the Maximum Power Capability subfield 786 are new subfields used by the power-controlled multi-link STR operation method 400. In these embodiments, the Local Power Constraint subfield 782 is coded as a two's complement signed integer in units of decibels relative to one (1) mW. The Minimum and Maximum Transmit Power Capability subfields 784 and 786 are set to the nominal minimum and maximum transmit powers, respectively, with which the STA 112 is capable of transmitting in the current channel, with a tolerance of, for example, +5 dB. Each of these subfields 784 and 786 is coded as a two's complement signed integer in units of decibels relative to one (1) mW.

In some embodiments, a receiving AP MLD 302 or non-AP MLD 312 determines the end of the STA Info field 708 based on the STA Info Length subfield 772 of the STA Info field 708 in the Per-STA profile subelement of the Reconfiguration Multi-Link element.

Herein, a power-controlled multi-link STR operation method 400 is disclosed, which is specifically designed for managing IDC interference in multi-link STR operations. In some embodiments, the power-controlled multi-link STR operation method disclosed herein includes signaling methods to facilitate efficient exchange of power information between AP and non-AP MLDs 302 and 312. In some embodiments, the power-controlled multi-link STR operation method disclosed herein uses an adaptive IDC-aware power-control method to adjust transmission power across multiple links, with consideration of various factors such as frequency separation between affiliated non-APs 112 and the presence of IDC interference, thereby enabling simultaneous uplink and downlink transmissions over IDC-impacted links while effectively managing the IDC interference.

In various embodiments, the power-controlled multi-link STR operation method disclosed herein solves several problems in the prior art, such as:

Managing the IDC interference in STR MLO: One of the technical problems
addressed is the managing the IDC interference in STR MLOs without the need to switch to NSTR modes. The method disclosed herein dynamically adjusts transmission power based on frequency separation and interference conditions, allowing for continued efficient STR operation in the presence of IDC, thereby leading to a significant improvement over prior-art approaches that often required switching to NSTR modes.
Minimizing delay in MLO in the presence of IDC interference: prior-art methods often require switching to the NSTR mode, which compromises the throughput and latency. The method disclosed herein provides an IDC-aware power-controlled STR mode that maintains as many of the inherent advantages of STR MLO, especially minimizing delay compared to the NSTR schemes.
Providing feasible mechanisms for delay-sensitive applications: Applying restricted rules listed in prior art might not be feasible in time-sensitive communications scenarios like IoT operations and online gaming, where the delay requirements are stringent. By effectively managing IDC interference in STR MLO, the method disclosed herein allows STR MLO to operate efficiently in the presence of IDC interference, especially in delay-sensitive applications, satisfying their delay constraints.
Simplifying network management: By providing clear and measurable criteria for power control in the presence of IDC interference, the method disclosed herein simplifies network management compared to previous approaches that often relied on complex synchronization or scheduling mechanisms.
Lack of standardized mechanisms for exchanging power capabilities and constraints information between MLDs in an MLO scenario. This lack of information exchange can lead to inefficient power management, potential interference issues, significant overhead, and suboptimal performance in MLO networks. The method disclosed herein uses extended elements and signaling approaches for exchanging power capabilities and constraints information to enhance the overall management of multi-link operations, thereby providing more granular control and flexibility.

In various embodiments, the power-controlled multi-link STR operation method disclosed herein provides various advantageous effects.

For example, unlike previous works that switch to the NSTR mode, the method disclosed herein adjusts the transmission power values on the IDC-impacted links, thereby enabling simultaneous uplink and downlink transmissions over IDC-impacted links and mitigating or even eliminating the otherwise significant issue of IDC interference in STR multi-link operations;

Accordingly, the method disclosed herein enables multi-link STR operations with maximized throughput and minimized latency, thereby exhibiting a significant improvement over prior-art methods that often require switching to NSTR mode which compromises the throughput and latency.

In some embodiments, the method disclosed herein is particularly beneficial for delay-sensitive applications such as IoT devices operations and online gaming, wherein the delay requirements are stringent, and applying restricted channel access or EDCA backoff suspension methods as in the NSTR mode may not be feasible in these scenarios.

In some embodiments, the method disclosed herein uses various signaling approaches for the power capabilities and constraints information exchange/update between AP/non-AP MLDs, such as extending the existing Power Capability and Power Constraint elements to multi-link operations, and/or introducing the UHR Basic Multi-Link element to include the power capabilities/constraint present and value subfields into the STA control and STA Info fields. A UHR Reconfiguration Multi-Link element is also introduced for providing recommendation for ML reconfiguration to the associated non-AP MLD(s) for updating the local transmit power constraint for an affiliated STA. These extended elements represent significant enhancements in the management of multi-link operations.

In some embodiments, the method disclosed herein provides a clear and measurable criterion for managing transmission power in a network to handle IDC interference during STR multi-link operations, which reduces the complexity involved in network management, and is a significant improvement over prior-art methods (which often involved complex end-time alignment, or TX/TX and/or RX/RX operations synchronization).

In some embodiments, the method disclosed herein provides flexible power control based on the frequency gap between affiliated STAs, the presence of IDC interference, and the dynamic changes of the network. Such a flexibility allows the system to maintain good performance and minimize interference in various scenarios, making it a more robust and adaptable solution.

C. Acronyms. Abbreviations. And Definition of Some Terms

| | Acronym/Abbreviation/ |
|---|---|
| Full Name | Initialism |
| Access Category | AC |
| Access Point | AP |
| Distributed Coordination Function | DCF |
| Downlink | DL |
| Enhanced Distributed Channel Access | EDCA |
| Enhanced Distributed Channel Access Function | EDCAF |
| Hybrid Coordination Function | HCF |
| In-Device Coexistence | IDC |
| Internet-of-Things | IoT |
| Multi-Link | ML |
| Multi-Link Device | MLD |
| Multi-Link Logical Entity | MLLE |
| Multi-Link Operation | MLO |
| Non-Simultaneous Transmit and Receive | NSTR |
| Physical | PHY |
| Reception | RX |
| Signal-to-Interference-and-Noise-Ratio | SINR |
| Simultaneous Transmit and Receive | STR |
| Station | STA |
| Target Beacon Transmission Time | TBTT |
| Transmission | TX |
| Transmission Opportunity | TXOP |
| Ultra-High Reliability | UHR |
| Uplink | UL |
| Wireless LAN | WLAN |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage media (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
receiving from a multi-link device (MLD) a minimum transmit power and a maximum transmit power for each of a first communication link and a second communication link; and
notifying the MLD to set a transmit power of each of the first and second communication links to a respective upper limit thereof;
wherein the upper limit of each of the first and second communication links is the respective maximum transmit power thereof if a frequency gap between the first communication link and the second communication link is greater than a threshold, or is the respective minimum transmit power thereof if the frequency gap is smaller than the threshold.

2. The method of claim 1, wherein said receiving from the MLD the minimum transmit power and the maximum transmit power for each of the first communication link and the second communication link comprises:
receiving, from the MLD via an association or reassociation request frame, the minimum and maximum transmit powers for each of the first and second communication links;
wherein the association or reassociation request frame comprises a Multi-Link Power Capability element, the Multi-Link Power Capability element comprising a Transmit Power Capabilities field; and
wherein the Transmit Power Capabilities field of the Multi-Link Power Capability element indicates the minimum and maximum transmit powers for each of the first and second communication links.

3. The method of claim 2, wherein said notifying the MLD to set the transmit power of each of the first and second communication links to the respective upper limit thereof comprises:
notifying the MLD, via an association or reassociation response frame, to set the transmit power of each of the first and second communication links to the respective upper limit thereof;
wherein the association or reassociation response frame comprises a Power Constraint element, the Power Constraint element comprising a Local Power Constraint field;
wherein the Local Power Constraint field of the Power Constraint element indicates the upper limit of each of the first and second communication links.

4. The method of claim 1, wherein said receiving from the MLD the minimum transmit power and the maximum transmit power for each of the first communication link and the second communication link comprises:
receiving, from the MLD via an association or reassociation request frame, the minimum and maximum transmit powers for each of the first and second communication links;
wherein the association or reassociation request frame comprises a first Ultra-High Reliability (UHR) Multi-Link element being a first UHR Basic Multi-Link element or a first UHR Reconfiguration Multi-Link element, the first UHR Multi-Link element comprising a Multi-Link Control field and a Link Info field;
wherein the Multi-Link Control field of the first UHR Multi-Link element comprises a Type subfield having a value of five or six;
wherein the Link Info field of the first UHR Multi-Link element comprises a plurality of Per-STA Profile subelements for the first and second communication links, respectively, each Per-STA Profile subelement comprising a STA Info field; and
wherein the STA Info field of the Per-STA Profile subelement of the first UHR Multi-Link element indicates the minimum and maximum transmit powers for the corresponding one of the first and second communication links.

5. The method of claim 4, wherein said notifying the MLD to set the transmit power of each of the first and second communication links to the respective upper limit thereof comprises:
notifying the MLD, via an association or reassociation response frame, to set the transmit power of each of the first and second communication links to the respective upper limit thereof;
wherein the association or reassociation request frame comprises a second UHR Multi-Link element being a second UHR Basic Multi-Link element or a second UHR Reconfiguration Multi-Link element, the second UHR Multi-Link element comprising a Multi-Link Control field and a Link Info field;
wherein the Multi-Link Control field of the second UHR Multi-Link element comprises a Type subfield having a value of five or six;
wherein the Link Info field of the second UHR Multi-Link element comprises a plurality of Per-STA Profile subelements for the first and second communication links, respectively, each Per-STA Profile subelement of the second UHR Multi-Link element comprising a STA Info field; and
wherein the STA Info field of the Per-STA Profile subelement of the second UHR Multi-Link element indicates the upper limit of each of the first and second communication links.

6. The method of claim 5, wherein the Multi-Link Control field of the second UHR Multi-Link element comprises a Type subfield having a value of six; and
wherein the STA Control field of the Per-STA Profile subelement of the second UHR Multi-Link element comprises a UHR Reconfiguration Operation Type subfield having a value five for indicating local power update.

7. One or more one or more processors functionally connected to one or more non-transitory computer-readable storage media for performing actions comprising:
receiving from a multi-link device (MLD) a minimum transmit power and a maximum transmit power for each of a first communication link and a second communication link; and
notifying the MLD to set a transmit power of each of the first and second communication links to a respective upper limit thereof;
wherein the upper limit of each of the first and second communication links is the respective maximum transmit power thereof if a frequency gap between the first communication link and the second communication link is greater than a threshold, or is the respective minimum transmit power thereof if the frequency gap is smaller than the threshold.

8. The one or more one or more processors of claim 7, wherein said receiving from the MLD the minimum transmit power and the maximum transmit power for each of the first communication link and the second communication link comprises:
receiving, from the MLD via an association or reassociation request frame, the minimum and maximum transmit powers for each of the first and second communication links;
wherein the association or reassociation request frame comprises a Multi-Link Power Capability element, the Multi-Link Power Capability element comprising a Transmit Power Capabilities field; and
wherein the Transmit Power Capabilities field of the Multi-Link Power Capability element indicates the minimum and maximum transmit powers for each of the first and second communication links.

9. The one or more one or more processors of claim 8, wherein said notifying the MLD to set the transmit power of each of the first and second communication links to the respective upper limit thereof comprises:
notifying the MLD, via an association or reassociation response frame, to set the transmit power of each of the first and second communication links to the respective upper limit thereof;
wherein the association or reassociation response frame comprises a Power Constraint element, the Power Constraint element comprising a Local Power Constraint field;
wherein the Local Power Constraint field of the Power Constraint element indicates the upper limit of each of the first and second communication links.

10. The one or more one or more processors of claim 7, wherein said receiving from the MLD the minimum transmit power and the maximum transmit power for each of the first communication link and the second communication link comprises:
receiving, from the MLD via an association or reassociation request frame, the minimum and maximum transmit powers for each of the first and second communication links;
wherein the association or reassociation request frame comprises a first Ultra-High Reliability (UHR) Multi-Link element being a first UHR Basic Multi-Link element or a first UHR Reconfiguration Multi-Link element, the first UHR Multi-Link element comprising a Multi-Link Control field and a Link Info field;
wherein the Multi-Link Control field of the first UHR Multi-Link element comprises a Type subfield having a value of five or six;
wherein the Link Info field of the first UHR Multi-Link element comprises a plurality of Per-STA Profile subelements for the first and second communication links, respectively, each Per-STA Profile subelement comprising a STA Info field; and
wherein the STA Info field of the Per-STA Profile subelement of the first UHR Multi-Link element indicates the minimum and maximum transmit powers for the corresponding one of the first and second communication links.

11. The one or more one or more processors of claim 10, wherein said notifying the MLD to set the transmit power of each of the first and second communication links to the respective upper limit thereof comprises:
notifying the MLD, via an association or reassociation response frame, to set the transmit power of each of the first and second communication links to the respective upper limit thereof;
wherein the association or reassociation request frame comprises a second UHR Multi-Link element being a second UHR Basic Multi-Link element or a second UHR Reconfiguration Multi-Link element, the second UHR Multi-Link element comprising a Multi-Link Control field and a Link Info field;
wherein the Multi-Link Control field of the second UHR Multi-Link element comprises a Type subfield having a value of five or six;
wherein the Link Info field of the second UHR Multi-Link element comprises a plurality of Per-STA Profile subelements for the first and second communication links, respectively, each Per-STA Profile subelement of the second UHR Multi-Link element comprising a STA Info field; and
wherein the STA Info field of the Per-STA Profile subelement of the second UHR Multi-Link element indicates the upper limit of each of the first and second communication links.

12. The one or more one or more processors of claim 11, wherein the Multi-Link Control field of the second UHR Multi-Link element comprises a Type subfield having a value of six; and
wherein the STA Control field of the Per-STA Profile subelement of the second UHR Multi-Link element comprises a UHR Reconfiguration Operation Type subfield having a value five for indicating local power update.

13. One or more non-transitory computer-readable storage media comprising computer-executable instructions, wherein the instructions, when executed, cause one or more processors to perform actions comprising:
receiving from a multi-link device (MLD) a minimum transmit power and a maximum transmit power for each of a first communication link and a second communication link; and
notifying the MLD to set a transmit power of each of the first and second communication links to a respective upper limit thereof;
wherein the upper limit of each of the first and second communication links is the respective maximum transmit power thereof if a frequency gap between the first communication link and the second communication link is greater than a threshold, or is the respective minimum transmit power thereof if the frequency gap is smaller than the threshold.

14. The one or more non-transitory computer-readable storage media of claim 13, wherein said receiving from the MLD the minimum transmit power and the maximum transmit power for each of the first communication link and the second communication link comprises:
receiving, from the MLD via an association or reassociation request frame, the minimum and maximum transmit powers for each of the first and second communication links;
wherein the association or reassociation request frame comprises a Multi-Link Power Capability element, the Multi-Link Power Capability element comprising a Transmit Power Capabilities field; and
wherein the Transmit Power Capabilities field of the Multi-Link Power Capability element indicates the minimum and maximum transmit powers for each of the first and second communication links.

15. The one or more non-transitory computer-readable storage media of claim 14, wherein said notifying the MLD to set the transmit power of each of the first and second communication links to the respective upper limit thereof comprises:
notifying the MLD, via an association or reassociation response frame, to set the transmit power of each of the first and second communication links to the respective upper limit thereof;
wherein the association or reassociation response frame comprises a Power Constraint element, the Power Constraint element comprising a Local Power Constraint field;
wherein the Local Power Constraint field of the Power Constraint element indicates the upper limit of each of the first and second communication links.

16. The one or more non-transitory computer-readable storage media of claim 13, wherein said receiving from the MLD the minimum transmit power and the maximum transmit power for each of the first communication link and the second communication link comprises:
receiving, from the MLD via an association or reassociation request frame, the minimum and maximum transmit powers for each of the first and second communication links;
wherein the association or reassociation request frame comprises a first Ultra-High Reliability (UHR) Multi-Link element being a first UHR Basic Multi-Link element or a first UHR Reconfiguration Multi-Link element, the first UHR Multi-Link element comprising a Multi-Link Control field and a Link Info field;
wherein the Multi-Link Control field of the first UHR Multi-Link element comprises a Type subfield having a value of five or six;
wherein the Link Info field of the first UHR Multi-Link element comprises a plurality of Per-STA Profile subelements for the first and second communication links, respectively, each Per-STA Profile subelement comprising a STA Info field; and
wherein the STA Info field of the Per-STA Profile subelement of the first UHR Multi-Link element indicates the minimum and maximum transmit powers for the corresponding one of the first and second communication links.

17. The one or more non-transitory computer-readable storage media of claim 16, wherein each Per-STA Profile subelement comprising a STA Control field; and
wherein the STA Control field of the Per-STA Profile subelement of the first UHR Multi-Link element comprises a Power Capabilities Present subfield having a value of one.

18. The one or more non-transitory computer-readable storage media of claim 16, wherein said notifying the MLD to set the transmit power of each of the first and second communication links to the respective upper limit thereof comprises:
notifying the MLD, via an association or reassociation response frame, to set the transmit power of each of the first and second communication links to the respective upper limit thereof;
wherein the association or reassociation request frame comprises a second UHR Multi-Link element being a second UHR Basic Multi-Link element or a second UHR Reconfiguration Multi-Link element, the second UHR Multi-Link element comprising a Multi-Link Control field and a Link Info field;
wherein the Multi-Link Control field of the second UHR Multi-Link element comprises a Type subfield having a value of five or six;
wherein the Link Info field of the second UHR Multi-Link element comprises a plurality of Per-STA Profile subelements for the first and second communication links, respectively, each Per-STA Profile subelement of the second UHR Multi-Link element comprising a STA Info field; and
wherein the STA Info field of the Per-STA Profile subelement of the second UHR Multi-Link element indicates the upper limit of each of the first and second communication links.

19. The one or more non-transitory computer-readable storage media of claim 18, wherein each Per-STA Profile subelement of the second UHR Multi-Link element comprising a STA Control field; and
wherein the STA Control field of the Per-STA Profile subelement of the second UHR Multi-Link element comprises a Local Power Constraint Present subfield having a value of one.

20. The one or more non-transitory computer-readable storage media of claim 18, wherein the Multi-Link Control field of the second UHR Multi-Link element comprises a Type subfield having a value of six; and
wherein the STA Control field of the Per-STA Profile subelement of the second UHR Multi-Link element comprises a UHR Reconfiguration Operation Type subfield having a value five for indicating local power update.
